(19) United States
(12) Patent Application Publication
(10) Pub. No.: US 2004/0034267 A1
(43) Pub. Date: Feb. 19, 2004

(54) Method for stabilization of material or waste to reduce combined metals leaching potential

(76) Inventor: Keith Edward Forrester, Meredith, NH (US)

Correspondence Address: Keith E. Forrester, 78 Tracy Way, Meredith, NH, 03253, US

(21) Appl. No.: 10/223,113

(22) Filed: Aug. 19, 2002

(51) Int. Cl. A62D 3/00

(52) U.S. Cl. 588/256

(57) ABSTRACT

This invention provides a method for chemical stabilization of combined heavy metal bearing materials and wastes subject to acid and water leaching tests or leach conditions by addition of stabilizing agents such that the leaching potential is inhibited to desired levels. The resultant material or waste after stabilization is deemed suitable for on-site reuse, off-site reuse or disposal as RCRA non-hazardous waste.

### BACKGROUND OF THE INVENTION

Over the past twenty years, the potential dangers of heavy metal bearing materials and waste has been the subject of community pressure, public awareness and ever stricter regulatory control in order to reduce or eliminate the dangers to people directly and to the surrounding environment. The leaching of heavy metals into groundwater is a grave concern because of the danger that the drinking water supplies and the environment will become contaminated. The leaching of heavy metals from most soil and wastes would result from solution into rainwater or surface waters . . . not necessarily from leaching from a solid waste landfill leaching environment as waste regulations in United States consider.

Heavy metal bearing materials and wastes, including sludge, ash, scrubber residues from air pollution control devices such as cyclones, electrostatic precipitators and bag-house filter bags, may be deemed hazardous by the United States Environmental Protection Agency (U.S. EPA) pursuant to 40 C.F.R. Part 261 if containing Se. Any solid waste can be defined as hazardous either because it is “listed” in 40 C.F.R., Part 261 Subpart D or because it exhibits one or more of the characteristics of a hazardous waste as defined at Part 261, Subpart C. These characteristics are: (1) ignitability, (2) corrosivity, (3) reactivity, and (4) toxicity as tested under the TCLP leaching procedure.

40 C.F.R., Part 261.24(a), contains a list of contaminants and their associated maximum allowable concentrations. If a contaminant, such as lead, exceeds its maximum allowable concentration, when tested using the Toxicity Characteristic Leaching Procedure (TCLP) analysis as specified at 40 C.F.R. Part 261 Appendix 2, then the material is classified as hazardous. The TCLP test uses a dilute acetic acid either in deionized water (TCLP fluid 2) or in deionized water with a sodium hydroxide buffer (TCLP fluid 1). Both extracts attempt to simulate the leachate character from a decomposing trash landfill in which the hazardous waste being tested for is assumed to be disposed of in and thus subject to the acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for defined metals. The TCLP test is designed to simulate a worst-case leaching situation, that is leaching conditions which would typically be found in the interior of an actively degrading municipal landfill. Such landfills normally are slightly acidic with a pH of approximately 5±0.5. Countries outside of the US also use the TCLP test as a measure of leachablity such as Thailand, Mexico, and Canada. Thailand also limits solubility of Cu and Zn, as these are metals of concern to Thailand groundwater. Switzerland regulates management of solid wastes by measuring heavy metals and salts as tested by a sequential leaching method using carbonated water simulating rainwater.

Additionally, U.S. EPA land disposal restrictions prohibit the land disposal of solid wastes which leach in excess of maximum allowable concentrations upon performance of the TCLP analysis. The land disposal regulations require that hazardous wastes are treated until the heavy metals do not leach at UTS levels from the solid waste at levels above the maximum allowable concentrations prior to placement in a surface impoundment, waste pile, landfill or other land disposal unit as defined in 40 C.F.R. 260.10.

Leach test conditions thus include the conditions to which a sludge, ash, waste, material or soil is subjected during dilute acetic acid leaching (TCLP), buffered citric acid leaching (STLC), distilled water, synthetic rainwater or carbonated water leaching (US SPLP, Japanese and Swiss and SW-924). Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached selenium is then analyzed by Inductively-Coupled Plasma (ICP) after filtration of a 100 ml aliquot from the tumbler through a 45 micron glass bead filter.

Of specific interest and concern regarding the present invention is the leaching of combined heavy metal groups such as Pb, Cd, Cu and Zn in sludge under TCLP as well as non-landfill conditions such as open industrial sites, waste storage cells, waste piles, waste monofills and under regulatory tests which attempt to simulate water leaching for determination of hazardousness of any given soil, material or waste.

The present invention provides a method of reducing the leachability of combined heavy metal bearing wastes including the groups Pb, Cu, Zn, and Cd and combinations thereof under TCLP, SPLP, CALWET, rainwater and surface water leaching conditions as well as under regulatory water extraction test conditions as defined by waste control regulations in Thailand, Japan, Switzerland, Germany, Sweden, The Netherlands and under American Nuclear Standards for sequential leaching of wastes by deionized water.

Unlike the present invention, prior art additives and mixtures have focused on reducing the leachability of single heavy metals such as Lead, Arsenic, Cadmium, Chromium under TCLP and landfill leaching conditions. Prior methods using Portland cement also produce a reduced permeability matrix or material with strength, whereas the present invention use of cement acts only to reduce metals solubility and is not applied with the intent or results of reducing permeability or increasing material of waste strength.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial waste water contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

Unlike the present invention, however, none of the prior art solutions were designed to allow specifically for stabilization of heavy metal bearing material or waste containing more than one specific heavy metal and also providing a one-step means for achieving leachability reduction of combinations of Pb, Cu, Zn and Cd in the waste or material matrix. The present invention also assures through the use of high water ratios and lack of aggregate that the material and wastes stabilized fail to form a cementious like material and thus are suitable for use and or disposal without having a cement-like permeability reduction or object strength.

### SUMMARY OF THE INVENTION

The present invention discloses a combined Pb, Cu, Zn and Cd heavy metal bearing material or waste stabilization method through contact of material or waste with stabilizing agents including phosphates, Portland cement, dolomitic lime, silicates, ferric chloride and combinations thereof which are properly chosen to complement the material or waste constituency and desired material or waste handling characteristics. The stabilizing agents proven effective are provided in both in dry and wet chemical form, and thus can be contacted with heavy metal bearing material either prior to waste production such as in-stream at wastewater facilities producing sludge or in-duct prior to air pollution control and ash collection devices or after waste production in material collection devices or waste piles.

It is anticipated that the stabilizers can be used for both RCRA compliance actions such that generated wastes or materials from wastewater facilities, furnaces, incinerators and other facilities do not exceed the TCLP hazardous waste criteria under TCLP or CERCLA (Superfund) response where stabilizers are added to waste piles or storage vessels previously generated. The preferred method of application of stabilizers would be in-line within the property and facility generating the heavy metal bearing material, and thus allowed under RCRA as a totally enclosed, in-tank or exempt method of TCLP stabilization without the need for a RCRA Part B hazardous waste treatment and storage facility permit.

### DETAILED DESCRIPTION

Environmental regulations throughout the world such as those promulgated by the USEPA under RCRA and CERCLA require heavy metal bearing waste and material producers to manage such materials and wastes in a manner safe to the environment and protective of human health. In response to these regulations, environmental engineers and scientists have developed numerous means to control heavy metals, mostly through chemical applications which convert the solubility of the material and waste character to a low exposure form, thus passing leach tests and allowing the wastes to be either reused on-site or disposed at local landfills without further and more expensive control means such as hazardous waste disposal landfills or facilities designed to provide metals stabilization. The primary focus of scientists has been on singular heavy metals such as lead, cadmium, chromium, arsenic and mercury, as these were and continue to be the most significant mass of metals contamination in soils. Materials such as paints, and cleanup site wastes such as battery acids and slag wastes from smelters are major lead sources. Recently, however, there exists a demand for control methods of heavy metals in combined forms such as sludge containing Pb, Cu, Zn and Cd combinations and from wastewater sludge, air pollution ashes and contaminated soils.

The present invention discloses a combined heavy metal bearing material or waste stabilization method through contact of material or waste with stabilizing agents including phosphates, Portland cement, silicates, quicklime, ferric chloride and combinations thereof. The stabilizing agents found effective are available in dry, slurry and wet chemical form, and thus can be contacted with heavy metal bearing material prior to waste generation such as in-stream at wastewater sludge producing plants or in-duct prior to air pollution control and ash collection devices or after waste production in collection devices such as hoppers, dump valves, conveyors, dumpsters or waste piles. The stabilizers are applied in a manner to utilize Portland cement as a stabilizing agent and not a cement-like additive thus allowing stabilized material and waste to remain suitable for fill material or loose handling.

It is anticipated that the stabilizers can be used for both RCRA compliance actions such that generated materials from wastewater facilities, furnaces, incinerators and other facilities do not exceed appropriate TCLP hazardous waste criteria under TCLP or CERCLA (Superfund) response where stabilizers are added to waste piles or storage vessels previously generated and now regulated under RCRA as a hazardous waste pre-disposal. The preferred method of application of stabilizers would be in-line within the property and facility generating the heavy metal bearing material, and thus allowed under RCRA as a totally enclosed, in-tank or exempt method of TCLP stabilization without the need for a RCRA Part B hazardous waste treatment and storage facility permit(s).

The use of Portland cement, silicates, quicklime, phosphates, ferric chloride and combinations with phosphates including but not limited to wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof would, as an example, provide various amount of phosphate, cement, silicates, lime, ferric chloride and or combination contact with material or waste. In certain cases such as use of amber and green acid, such acids embody sulfuric acid, vanadium, iron, aluminum and other complexing agents which could also provide for a single-step formation of complexed minerals. The phosphate, cement, silicate, lime, ferric chloride and combination type, size, dose rate, contact duration, and application means could be engineered for each type of heavy metal bearing material or waste.

Although the exact stabilization formation molecule(s) are unknown at this time, it is expected that when heavy metals comes into contact with the stabilizing agent(s), low water and low acid soluble compound(s) begin to form such as a mineral phosphate, twinned mineral, mononuclear silicate layers or precipitate through substitution or surface bonding, which is less soluble than the heavy metal element or molecule originally in the material or waste. Specifically complexing and/or twinning of Pb, Cu, Zn and Cd into pyromorphite amorphous crystals most likely occurs by adding calcium phosphate(s) to the material or waste at standard temperature and pressure. It also remains possible that modifications to temperature and pressure may accelerate of assist formation of minerals, although such methods are not considered optimal for this application given the need to limit cost and provide for optional field based stabilizing operations that would be complicated by the need for pressure and temperature control devices and vessels.

In another method, heavy metal bearing material or waste is contacted with at least one phosphate in the presence of a complexing agent selected to generate specific mineral on the heavy metal bearing material or waste. The complexing agent could include iron, aluminum, calcium, chlorides, sulfates, vanadium, and various other complexing agents which provide for or assist in formation of TCLP and other leach test low solubility minerals. Use of phosphates in the presence of complex agents for mineral formations of lead bearing wastes is taught by U.S. Pat. No. 5,722,928 issued to Forrester.

Examples of suitable stabilizing agents include, but are not limited to, Portland cement, ferric chloride, phosphate fertilizers, phosphate rock, pulverized phosphate rock, calcium orthophosphates, monocalcium phosphate, dicalcium phosphate, tricalcium phosphate, trisodium phosphates, calcium oxide (quicklime), dolomitic quicklime, silicates, sodium silicates, potassium silicates, natural phosphates, phosphoric acids, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof

The amounts of stabilizing agent used, according to the method of invention, depend on various factors including desired solubility reduction potential, desired mineral toxicity, and desired mineral formation relating to toxicological and site environmental control objectives. It has been found that an amount of certain stabilizing agents such as 10% Portland cement and 2% sodium silicate, and 15% Portland cement with 1% amber wet process phosphoric acid and 1% ferric chloride, by weight of Pb, Cu, Zn and Cd bearing sludge material or waste is sufficient for initial TCLP stabilization to less than RCRA limits. However, the foregoing is not intended to preclude yet higher or lower usage of stabilizing agent or combinations if needed since it has been demonstrated that amounts greater than 15% cement and phosphate by weight also work, but are more costly.

The examples below are merely illustrative of this invention and are not intended to limit it thereby in any way.

### EXAMPLE 1

In this example Thailand wastewater industrial sludge was stabilized with varying amounts of stabilizing agents including amber phosphoric acid (WAA), Portland cement type A/B (PC), sodium silicate (NS) and 30% ferric chloride solution (FC) with 30 days of sample curing pre-extraction. Both stabilized and un-stabilized sludge were subsequently tested for TCLP Pb, Cd, Cu and Zn. Samples were extracted according to TCLP procedure set forth in Federal Register, Vol. 55, No. 126, pp. 26985-26998 (Jun. 29, 199), which is hereby incorporated by reference. The leachate was digested prior to analysis by ICP.

TABLE 1

| | TCLP Pb—Cd—Cu—Zn |
|---|---|
| Stabilizer Dose (%) | (ppm) |
| 0 | 45-4-276-780 |
| 10 Cement + 2 Silicate + 15 H20 | ND-ND-ND-ND |
| 15 Cement + 3 Silicate + 15 H20 | ND-ND-ND-ND |
| 15 Cement + 1 Amber + 1 Ferric Chloride | ND-ND-ND-ND |

(Cement produced residue with less than 30 PSI unconfined strength)

### EXAMPLE 2

In this example Switzerland industrial ash was stabilized with varying amounts of stabilizing agents including triple superphosphate (TSP), amber phosphoric acid (WAA), Portland cement type A/B (PC), sodium silicate (NS) with 30 days of sample curing pre-extraction. Both stabilized and un-stabilized sludge were subsequently tested for water leachable Pb, Cd, Cu and Zn. Samples were extracted according to the sequential carbonated water Swiss procedure. The leachate was digested prior to analysis by ICP.

TABLE 2

| Stabilizer Dose (%) | DI Pb—Cd—Cu—Zn (ppm) |
|---|---|
| 0 | 0.04-0.02-0.34-0.23 |
| 5 Cement | 0.02-ND-0.28-0.18 |
| 5 Cement + 5 TSP + 20 H20 | ND-ND-ND-ND |
| 5 Cement + 3 Silicate + 20 H20 | ND-ND-ND-ND |
| 5 Cement + 5 Amber + 20 H20 | ND-ND-ND-ND |

(Cement produced residue with less than 30 PSI unconfined strength)

The foregoing results in Table 1 and Table 2 readily established the operability of the present process to stabilize combined Pb, Cd, Cu and Zn thus reducing leachability and bioavailability. Given the effectiveness of the stabilizing agents in causing combined heavy metals to stabilize as presented in the Table 1, it is believed that an amount of the stabilizing agents equivalent to less than 5% by weight of heavy metal bearing material or waste should be effective. It is also apparent from the Table 1 and Table 2 results that certain stabilizing agents and complexing blends are more effective for stabilization.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of combined heavy metal bearing material or waste, comprising contacting heavy metal bearing material or waste with at least one stabilizing agent in an amount effective in reducing the leaching of combined heavy metals from the material or waste to a level no more than non-hazardous levels as determined in an EPA TCLP test, performed on the stabilized material or waste, as set forth in the Federal Register, vol. 55, no. 126, pp. 26985-26998 (Jun. 29, 1990).

2. The method of claim 1, wherein the stabilizing agent is selected from the group consisting of phosphates, Portland cement, silicates, lime, phosphates, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

3. The method of claim 2, wherein the salts of phosphoric acid are alkali metal salts.

4. The method of claim 2, wherein the phosphate salt is a trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

5. The method of claim 2, wherein the phosphate and complexing agent as iron, calcium, chloride, or aluminum are supplied as one product including triple superphosphate, wet process phosphoric acid and combination fertilizer mixtures.

6. The method of claim 2, wherein the stabilizing complexing agents are selected from polymer, calcium chloride, sodium chloride, potassium chloride, vanadium, boron, iron, aluminum, sulfates, sulfides or combinations thereof.

7. The method of claim 1 wherein Pb, Cd, Cu and Zn bearing sludge is contacted with at least on stabilizing agent in effective amount to reduce leaching to TCLP non-hazardous or desired levels prior to collection of such sludge in containers.

8. The method of claim 1 wherein Pb, Cd, Cu and Zn bearing sludge is contacted with at least on stabilizing agent in effective amount to reduce leaching to TCLP non-hazardous or desired levels during or after collection of such sludge in containers or during or after generation of sludge as a regulated waste.

9. A method of reducing the solubility of combined heavy metal bearing material or waste, comprising contacting heavy metal bearing material or waste with at least one stabilizing agent in an amount effective in reducing the leaching of combined heavy metals from the material or waste to a level no more than non-hazardous levels as determined in Swiss sequential water leach test, performed on the stabilized material or waste.

10. The method of claim 1, wherein the stabilizing agent is selected from the group consisting of phosphates, Portland cement, silicates, lime, phosphates, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

11. The method of claim 1 wherein Pb, Cd, Cu and Zn bearing ash is contacted with at least on stabilizing agent in effective amount to reduce water leaching to non-hazardous or desired levels prior to collection of such sludge in containers.

12. The method of claim 1 wherein Pb, Cd, Cu and Zn bearing ash is contacted with at least on stabilizing agent in effective amount to reduce water leaching to non-hazardous or desired levels during or after collection of such ash in containers or during or after generation of ash as a regulated waste.
